(19) United States
(12) Patent Application Publication
(10) Pub. No.: US 2013/0180520 A1
(43) Pub. Date: Jul. 18, 2013

(54) THERMAL ENERGY STORAGE WITH MOLTEN SALT

(71) Applicants: Justin Raade, San Francisco, CA (US); Benjamin Elkin, San Francisco, CA (US)

(72) Inventors: Justin Raade, San Francisco, CA (US); Benjamin Elkin, San Francisco, CA (US)

(73) Assignee: Halotechnics, Inc., Emeryville, CA (US)

(21) Appl. No.: 13/491,058

(22) Filed: Jun. 7, 2012

Related U.S. Application Data
(60) Provisional application No. 61/494,272, filed on Jun. 7, 2011.

(51) Int. Cl. C09K 5/12; F24J 2/34

(52) U.S. Cl. CPC C09K 5/12; F24J 2/34
USPC 126/714; 252/71

(57) ABSTRACT

Several systems of thermally stable inorganic salts with low melting points are disclosed. These compositions include earth-abundant salt materials and can have thermal stability limits greater than 700° C.

### CROSS-REFERENCES TO RELATED APPLICATIONS

This application claims priority to U.S. Provisional Application No. 61/494,272, filed Jun. 7, 2011, which is incorporated in its entirety herein for all purposes.

### STATEMENT AS TO RIGHTS TO INVENTIONS MADE UNDER FEDERALLY SPONSORED RESEARCH AND DEVELOPMENT

This invention was made with Government support under Award No. IIP-1047450 awarded by the National Science Foundation. The Government has certain rights in this invention.

### BACKGROUND OF THE PRESENT INVENTION

Current commercially deployed thermal storage systems are two-tank sensible heat designs using molten salt as the thermal storage media [S. Relloso and E. Delgado, “Experience with molten salt thermal storage,” SolarPACES, 2009]. The most significant drawback of this technology is its high capital cost—over $80/kWht [J. Stekli, “Thermal Energy Storage Research,” ARPA-E Thermal Storage Workshop, 2011]. Today's plants using this technology have a small temperature difference between the hot tank (at 400° C.) and the cold tank (at 300° C.).

Molten salts of many varieties are currently available in large commercial quantities from several suppliers. The current standard heat transfer fluid (HTF) considered for central receiver applications is called “draw salt” (a mixture of sodium nitrate and potassium nitrate, sold under the brand name Hitec) with a melting point of 240° C. and a maximum temperature of 593° C. [“Hitec solar salt,” Coastal Chemical Co., LLC]. This relatively narrow operating range limits the performance of central receiver plants. On the upper end, current plants are limited to 565° C. operating temperature due to increasing thermal breakdown of draw salt at higher temperatures.

Increasing the maximum fluid output temperature of central receiver plants from 565° C. to 700° C. would enable the plant to produce more electricity from the same energy input by increasing the thermal conversion efficiency of the power block. Today's steam turbines used for commercial CSP plants achieve a gross conversion efficiency of just 38% [“Concentrating Solar Power Projects: Andasol-1,” NREL, 2011], constrained primarily by their lower operating temperature (under 400° C.). A state of the art supercritical steam turbine with an inlet temperature of 620° C. can achieve a conversion efficiency of approximately 45%. A molten salt material and thermal storage system with operating temperatures tailored to commercially available steam turbines could therefore dramatically improve system efficiency. This improvement would reduce the levelized energy cost [G. J. Kolb, “Conceptual design of an advanced through utilizing a molten salt working fluid,” presented at SolarPACES Symposium, Las Vegas, Nev., 2008]. A higher operating temperature would also reduce thermal storage costs by using a greater temperature differential for sensible heat storage.

Accordingly, there exists a need for an affordable molten salt heat transfer fluid that is composed of low-cost materials and exhibits a broad operating temperature range and high thermal stability. Surprisingly, the present invention addresses this and other needs.

### BRIEF SUMMARY OF THE PRESENT INVENTION

In one embodiment, the present invention provides a composition including: a lithium cation, in an amount of from about 0 to about 55 mol % based on the cations; a sodium cation, in an amount of from about 0 to about 20 mol % based on the cations; a potassium cation, in an amount of from about 15 to about 50 mol % based on the cations; a cesium cation, in an amount of from about 0 to about 35 mol % based on the cations; a strontium cation, in an amount of from about 0 to about 10 mol % based on the cations; and a chloride anion in an amount of 100 mol % based on the anions.

In a second aspect, the present invention provides a method for storing solar thermal energy. The method includes exposing a composition of the present invention to sunlight.

### BRIEF DESCRIPTION OF THE DRAWINGS

FIG. 1 shows the design of a thermal storage system with an operating temperature of a 700° C. The dashed lines indicate the boundaries of the system.

FIG. 2 shows the cross section of the internally insulated tank in the 700° C. thermal storage system.

FIG. 3 shows the temperature profile, proceeding radially outward from center of tank, in the 700° C. thermal storage system.

FIG. 4 shows representative phase diagrams showing the liquidus temperature of Li-Na-K-Cs-Sr-Cl mixtures near the eutectic point.

FIG. 5 shows the thermogram, including the melting point and heat of fusion, for Saltstream 700.

FIG. 6 shows a TGA profile, indicating the thermal stability, for Saltstream 700.

FIG. 7 shows the viscosity of Saltstream 700 plotted as a function of temperature.

### DETAILED DESCRIPTION OF THE PRESENT INVENTION

### I. General

The present invention provides new molten salt materials suitable for heat transfer and thermal energy storage applications. The inventive materials are novel eutectic chloride mixtures. The surprising properties of the inventive compositions were discovered by analyzing hundreds of different combinations of salts, and experimental data was complemented with FactSage thermodynamic modeling of multicomponent mixtures. In general, the novel eutectic mixtures contain stable inorganic salts and are characterized by melting points near 250° C. and maximum operating temperatures of at least 700° C. These advanced molten salts represent a breakthrough in a high performance theimal storage material. A particularly useful composition, called “Saltstream 700,” enables unprecedented efficiency with thermal energy storage exploiting sensible heat.

The present inventors have developed a thermal storage system utilizing the inventive compositions as the heat transfer and thermal storage material. The design includes a two-tank thermal storage system operating at a hot temperature of 700° C. and a cold temperature of 300° C. The system can be used to pump, heat, and store the inventive compositions. The molten salt thermal storage system has the potential to reduce thermal storage costs by a factor of five when implemented on a commercial scale.

### II. Definitions

“Cation” refers to chemical elements or counterions having a positive charge. The positive charge can be +1, +2, +3, or greater. Exemplary cations of the present invention include, but are not limited to, Li⁺, K⁺, Na⁺, and Cs⁺ and Sr²⁺. Other cations are useful in the present invention.

“Anion” refers to chemical elements and counterions having a negative charge. The negative charge can be −1, −2, −3, or greater. Exemplary anions of the present invention include CF. Other anions are useful in the present invention.

### III. Compositions

Molten salts exhibit many desirable heat transfer qualities at high temperatures. They have high density, high heat capacity, high thermal stability, and very low vapor pressure even at elevated temperatures. Their viscosity is low enough for sufficient pumping at high temperatures, and many are compatible with common stainless steels.

Accordingly, the present invention provides a composition including a lithium cation, a sodium cation, a potassium cation, a cesium cation, a strontium cation, and a chloride anion. As used herein, the terms “lithium,” “sodium,” “potassium,” “cesium,” and “strontium” refer to the corresponding cations unless otherwise specified. In some embodiments, the present invention provides a composition containing: a lithium cation, in an amount of from about 0 to about 55 mol % based on the cations; a sodium cation, in an amount of from about 0 to about 20 mol % based on the cations; a potassium cation, in an amount of from about 15 to about 50 mol % based on the cations; a cesium cation, in an amount of from about 0 to about 35 mol % based on the cations; a strontium cation, in an amount of from about 0 to about 10 mol % based on the cations; and a chloride anion in an amount of 100 mol % based on the anions.

Any suitable amount of lithium can be used in the compositions of the present invention. In general, the compositions include from about 0 mol % to about 55 mol % lithium (based on the cations in the composition). In some embodiments, the compositions can include, for example, from about 1 mol % to about 55 mol % lithium, or from about 10 mol % to about 55 mol % lithium, or from about 20 mol % to about 55 mol % lithium, or from about 30 mol % to about 55 mol % lithium, or from about 40 mol % to about 55 mol % lithium, or from about 40 mol % to about 50 mol % lithium. In some embodiments, the compositions can include about 40, 41, 42, 43, 44, 45, 46, 47, 48, 49, or 50 mol % lithium. In some embodiments, the composition includes a lithium cation in an amount of from about 1 to about 55 mol % based on the cations. In some embodiments, the composition includes a lithium cation in an amount of from about 30 to about 55 mol % based on the cations. In some embodiments, the composition includes a lithium cation in an amount of from about 40 to about 50 mol % based on the cations. In some embodiments, the composition can include the lithium cation in an amount of about 46 mol % based on the cations.

Any suitable amount of sodium can be used in the compositions of the present invention. In general, the compositions can include from about 0 mol % to about 20 mol % sodium (based on the cations in the composition). In some embodiments, the compositions can include, for example, from about 0.1 mol % to about 20 mol % sodium, or from about 0.1 mol % to about 15 mol % sodium, or from about 0.1 mol % to about 10 mol % sodium, or from about 1 mol % to about 10 mol % sodium. In some embodiments, the compositions can include about 1, 2, 3, 4, 5, 6, 7, 8, 9, or 10 mol % sodium. In some embodiments, the composition includes a sodium cation in an amount of from about 0.1 to about 10 mol % based on the cations. In some embodiments, the composition includes a sodium cation in an amount of from about 1 to about 10 mol % based on the cations. In some embodiments, the composition can include the sodium cation in an amount of about 4 mol % based on the cations.

Any suitable amount of potassium can be used in the compositions of the present invention. In general, the compositions can include from about 15 mol % to about 50 mol % potassium (based on the cations in the composition). In some embodiments, the compositions can include, for example, from about 15 mol % to about 45 mol % potassium, or from about 15 mol % to about 40 mol % potassium, or from about 15 mol % to about 35 mol % potassium, or from about 15 mol % to about 30 mol % potassium. In some embodiments, the compositions can include about 15, 16, 17, 18, 19, 20, 21, 22, 23, 24, 25, 26, 27, 28, 29, or 30 mol % potassium. In some embodiments, the composition includes a potassium cation in an amount of from about 15 to about 30 mol % based on the cations. In some embodiments, the composition can include the potassium cation in an amount of about 22 mol % based on the cations.

Any suitable amount of cesium can be used in the compositions of the present invention. In general, the compositions can include from about 0 mol % to about 35 mol % cesium (based on the cations in the composition). In some embodiments, the compositions can include, for example, from about 5 mol % to about 35 mol % cesium, or from about 10 mol % to about 35 mol % cesium, or from about 15 mol % to about 35 mol % cesium, or from about 20 mol % to about 30 mol % cesium. In some embodiments, the compositions can include about 20, 21, 22, 23, 24, 25, 26, 27, 28, 29 or 30 mol % cesium. In some embodiments, the composition includes a cesium cation in an amount of from about 10 to about 35 mol % based on the cations. In some embodiments, the composition includes a cesium cation in an amount of from about 20 to about 30 mol % based on the cations. In some embodiments, the composition can include the cesium cation in an amount of about 25 mol % based on the cations.

Any suitable amount of strontium can be used in the compositions of the present invention. In general, the compositions can include from about 0 mol % to about 10 mol % strontium (based on the cations in the composition). In some embodiments, the compositions can include, for example, from about 0.1 mol % to about 10 mol % strontium, or from about 0.1 mol % to about 5 mol % strontium, or from about 1 mol % to about 5 mol % strontium. In some embodiments, the compositions can include about 1, 2, 3, 4, 5, 6, 7, 8, 9, or 10 mol % strontium. In some embodiments, the compositions can include the strontium cation in an amount from about 0.1 mol % to about 5 mol % of the cations. In some embodiments, the compositions can include the strontium cation in an amount from about 1 mol % to about 5 mol % of the cations. In some embodiments, the compositions can include the strontium cation in an amount of about 3 mol % based on the cations.

Strontium cations useful in the compositions of the present invention can have any suitable oxidation states. For example, the strontium cations can be +1 or +2. In some embodiments, the strontium cations can have the +2 oxidation state.

Any suitable amount of chloride can be used in the compositions of the present invention. In general, the compositions include about 100 mol % chloride (based on the anions in the composition). Other amounts of chloride may be useful in the compositions of the present invention.

The compositions of the present invention can be prepared by any method known to one of skill in the art. For example, salt components can be dispensed into a suitable container, such as a crucible, and weighed using a scientific balance accurate to 0.01 mg. Salt mixtures can be formulated using automated equipment for measuring each component as it is being dispensed and recording the final weight of a given mixture. A salt mixture can be ground with a mortar and pestle, prior to melting and homogenization in a furnace under suitable conditions. The mixture can be heated, for example, in a furnace at 150° C. for 4 hours to remove any water absorbed in the salt. The mixture can be further heated to ensure complete melting and homogenization. For example, the mixture can be heated for an additional 8 hours at 500° C. The compositions can be stored with a desiccant until characterized and/or used.

Typically, a sample containing 250 mg of a salt mixture is suitable for analyzing physical properties. A 30 kWht thermal storage prototype requires approximately 290 kg of molten salt. The equation for thermal energy storage is:

Q=mc_{P}(Tₕₒₜ−T_{cold})

Where c_{P} is the measured value for heat capacity, Tₕₒₜ−T_{cold}=400° C. for the difference in temperature between the hot tank and cold tank, and Q=30 kWht for the desired amount of stored energy. This equation can be solved for the required storage media mass m. To produce the required quantity of molten salt, raw materials can be procured from commercial vendors. The necessary salt inventory can be manufactured using a process called spray drying. In this process, salt components are first dissolved in water and then atomized so as to dehydrate the mixture in the air and yield a fine powder product. The powdered state eases handling and loading logistics of the salt into the thermal storage system. The composition of the final powder product can be verified using standard chemical analysis techniques.

A composition of the present invention can be described by specifying its composition, melting point, and thermal stability. Additional properties that are relevant for heat transfer fluid applications include the viscosity, specific heat, thermal conductivity, density, and vapor pressure. These properties can be measured using standard methods. The materials compatibility of the present invention with common alloys of steel is also important; this property can be measured with custom corrosion hardware.

A molten salt with a broad operating range (low melting point, high thermal stability) is useful for applications in addition to concentrating solar power, such as heat transfer and heat storage with industrial processes, heat treating of metals, and as an electrolyte in thermal batteries [P. Masset and R. Guidotti, “Thermal activated (thermal) battery technology Part II. Molten salt electrolytes,” J. Power Sources, vol. 164, pp. 397-414, 2007]. For heat treating applications, the chemical interaction of the present invention with the heat treated metal should be understood in the relevant temperature range. For electrolyte applications, the ionic conductivity of the present invention should be measured as well as the compatibility with anode and cathode materials. Extensive data exists for binary and ternary phase diagrams of inorganic salts [Phase Diagrams for Ceramists, American Ceramic Society/NIST, vol. 1-4, 7, 1964-1989.].

The compositions of the present invention can have any suitable melting point. The melting point can be, for example, less than about 300° C., or less than about 275° C., or less than about 250° C. The melting point can be about 245, 250, 255, 260, or 265° C. In some embodiments, the composition has a melting point of about 250° C. In some embodiments, the composition has a melting point of about 253° C.

The compositions of the present invention can have any suitable thermal stability limit. The thermal stability limit can be, for example, greater than about 400° C., or greater than about 450, 500, 550, 600, 650, or 700° C. In some embodiments, the composition has a thermal stability limit greater than about 565° C. In some embodiments, the composition has a thermal stability limit greater than about 700° C.

The melting point of a mixture can be determined by heating a sample at a controlled rate and using an optical method to record the temperature at which each mixture transitions from opaque to clear. This transition corresponds to the liquidus temperature, which is defined as the temperature during heating at which the last remaining solid phase melts and becomes liquid. The liquidus temperature is also equivalent to the temperature during cooling at which a solid phase first appears in the melt. A differential scanning calorimeter (DSC) can also be used to measure the melting point of a composition, as well as other relevant thermal properties including heat of fusion and heat capacity. Suitable calorimeters include the TA Instruments 2920 DSC.

The thermal stability limit of a mixture can be measured using a thermogravimetric analysis (TGA) device. The TGA device heats a sample in a controlled environment and continuously measures the sample weight, which typically decreases at higher temperatures as the sample decomposes into gaseous products. The thermal stability limit of a sample can be assessed by determining the temperature at which it has lost a defined percentage of its anhydrous weight during a TGA temperature ramp. Certain TGA devices, such as the TA Instruments Q500 TGA, can achieve temperatures of up to 1000° C. Testing can be conducted and compared under different atmospheres, such as a reactive atmosphere (e.g., air) or an inert atmosphere (e.g., nitrogen), in order to determine the effects of oxidation on the thermal stability limit.

In some embodiments, the present invention provides a composition termed Saltstream 700. The properties of Saltstream 700 are summarized in Table 1.

TABLE 1
Physical Properties of Saltstream 700

| Property | Value | | Method |
|---|---|---|---|
| Composition (mol %) | 46.4% | LiCl | Measured during |
| | 4.0% | NaCl | synthesis |
| | 21.8% | KCl | |
| | 2.9% | SrCl₂ | |
| | 24.9% | CsCl | |
| Composition (wt %) | 23.2% | LiCl | Measured during |
| | 2.8% | NaCl | synthesis |
| | 19.2% | KCl | |
| | 5.4% | SrCl₂ | |
| | 49.4% | CsCl | |
| Melting point | 253° | C. | DSC |
| Heat of fusion | 98 | J/g | DSC |
| Heat capacity | 1.45 J/g-K @ 300° C. | | DSC |
| T3 stability in air | 747° | C. | TGA |
| T3 stability in nitrogen | 751° | C. | TGA |

| | | |
|---|---|---|
| Long term stability | pH = 5 before test | Furnace, 168 hrs. |
| at 700° C. | pH = 7 after test | |
| Density | 2.26 g/cm³@ 300° C. | calculated |
| | 2.03 g/cm³@ 700° C. | |
| Corrosion rate | 0.04% decrease in mass of | |
| | 316 SS rod after 3 hours @ | |
| | 300° C. | |
| Viscosity | 8.4 cP @ 400° C. | Rotating spindle |
| | 4.2 cP @ 500° C. | viscometer |

### IV. Methods for Storing Solar Thermal Energy

In another aspect, the present invention provides a method for storing solar thermal energy. The method includes exposing a salt composition to sunlight, wherein the composition contains: a lithium cation, in an amount of from about 0 to about 55 mol % based on the cations; a sodium cation, in an amount of from about 0 to about 20 mol % based on the cations; a potassium cation, in an amount of from about 15 to about 50 mol % based on the cations; a cesium cation, in an amount of from about 0 to about 35 mol % based on the cations; a strontium cation, in an amount of from about 0 to about 10 mol % based on the cations; and a chloride anion in an amount of 100 mol % based on the anions.

Any of the compositions described above can be useful in the methods of the present invention. In some embodiments, the composition used in the methods of the present invention contains: the lithium cation, in an amount of from about 40 to about 50 mol % based on the cations; the sodium cation, in an amount of from about 0.1 to about 10 mol % based on the cations; the potassium cation, in an amount of from about 15 to about 30 mol % based on the cations; the cesium cation, in an amount of from about 20 to about 30 mol % based on the cations; the strontium cation, in an amount of from about 0.1 to about 5 mol % based on the cations; and the chloride anion in an amount of 100 mol % based on the anions.

In some embodiments, the composition used in the methods of the present invention contains: the lithium cation, in an amount of about 46 mol % based on the cations; the sodium cation, in an amount of about 4 mol % based on the cations; the potassium cation, in an amount of about 22 mol % based on the cations; the cesium cation, in an amount of about 25 mol % based on the cations; the strontium cation, in an amount of about 3 mol % based on the cations; and the chloride anion in an amount of 100 mol % based on the anions.

Various apparatuses for concentrated solar power (CSP) are known in the art and are suitable for use in the methods of the present invention. The inventors have designed an improved laboratory scale mini-CSP plant, with several important components developed with an eye toward scalability to commercial size. This systematic approach eliminates the greatest amount of risk from critical components of the molten salt thermal storage system. A pipe passing through a tube furnace is used to simulate the radiant heating environment of salt flowing through the tubes of a receiver. The system includes a molten salt pump using a long-shaft design conceptually similar to commercial-size molten salt pumps. Industrially relevant alloys can be used for piping and tank construction, as opposed to specialty items available only for small-scale niche applications. The system includes a novel 700° C. tank that is internally insulated with ceramic materials available in bulk quantities. This tank design will lend itself to scale-up for storage of thousands of tons of salt and eliminate the need for expensive nickel alloy construction. A 300° C. tank, scaled directly from the cold salt tank design used at today's commercial CSP plants (such as Andasol and Gemasolar), is also included.

This new system increases by a factor of four the temperature difference in the storage system, resulting in equal heat being stored with 1/4th the material relative to the state of the art technology. A significant reduction in the cost per unit energy stored when the inventive system is implemented on a commercial scale, even when the higher cost of high temperature structural materials is included in the cost estimate.

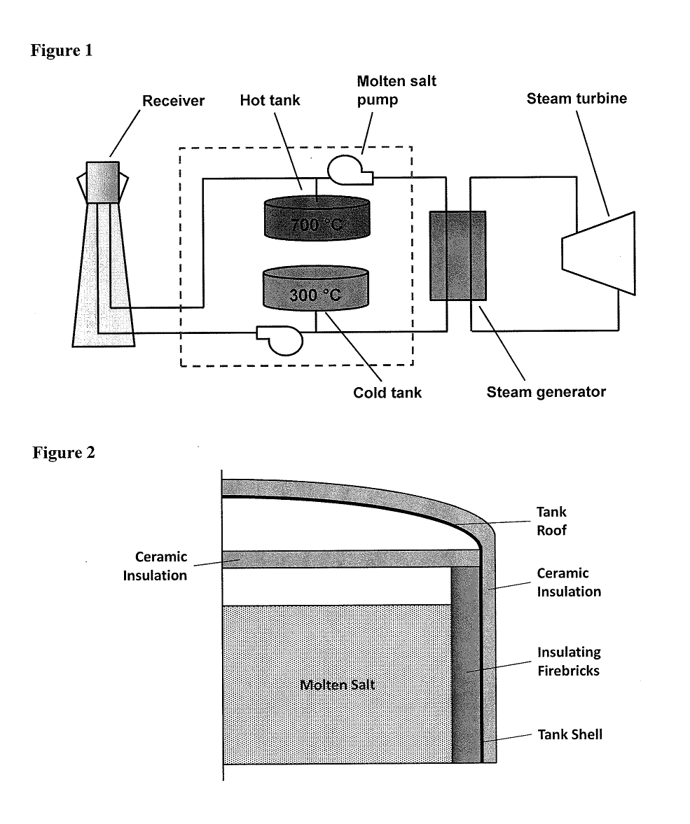

A diagram of the advanced sensible heat thermal storage system is shown in FIG. 1. In place of a central receiver, a standard laboratory tube furnace is used to heat the molten salt as it flows through the pipes. In place of a steam generator, a radiator heat sink is used to discharge the thermal energy.

Table 2 shows certain important performance parameters relevant for this advanced thermal storage system.

TABLE 2
Performance Parameters of the Inventive CSP System

| No. | Metric | Value |
|---|---|---|
| 1 | Thermal storage temperature | 700° C. |
| 2 | Cost of storage system (target at full scale) | $15/kWht |
| 3 | Round trip exergetic efficiency (target at | 98% |
| | full scale) | |
| 4 | Peak thermal power for charge/discharge | 5 kWt |
| 5 | Stored energy | 30 kWht |

Tank Design. The present invention provides an internally insulated tank for storing molten salt at 700° C. [R. Gabrielli, C. Zamparelli, Journal of Solar Energy Engineering, vol. 131, 2009]. In contrast to previous designs, the internal stainless steel membrane, which was prone to failure and added considerable expense in labor during tank construction, has been eliminated. The new design uses ceramic in direct contact with the molten salt. This type of ceramic liner has been used in the molten salt bath heat treating industry. These salt baths can be used at temperatures exceeding 850° C. with molten chloride salts and are capable of providing years of service. The internal insulation can be, but is not limited to, a silica ceramic known as KX-99. KX-99 costs approximately $1 per kg when purchased in bulk quantities. The exterior of the tank can be constructed of a steel alloy since it is thermally isolated from the hot interior. In this manner, the steel housing provides rupture strength but is insulated from the high temperature inside the core of the tank. The exterior of the steel is surrounded by a low-cost insulation material. The new design will result in a low cost device with a long operating life. A cross sectional diagram of the design is shown in FIG. 2.

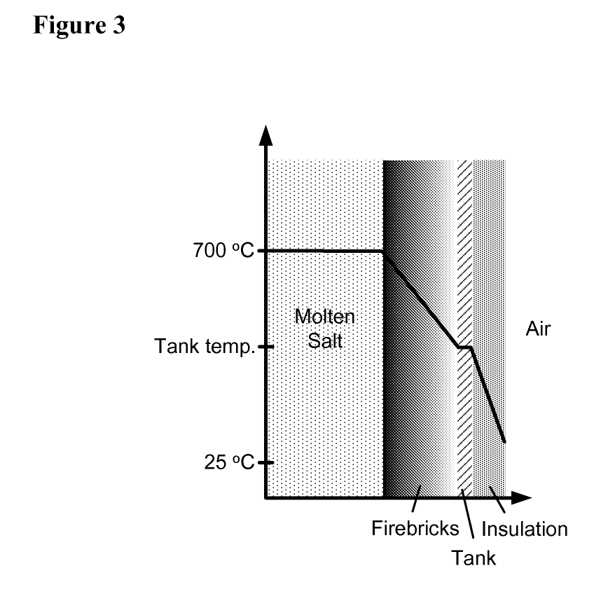

The thickness of the internal and external insulation affects the temperature of the steel housing and therefore drives the materials selection of the tank. The new design is a balance of many tradeoffs. Increasing the thickness of the external insulation decreases thermal losses, increasing charge/discharge efficiency, but also increases the temperature of the steel structure which may necessitate more expensive alloys. Similarly, increasing the thickness of the internal insulation reduces the temperature of the steel housing but requires more ceramic material and more labor expense to construct the complete tank. FIG. 3 shows the profile of the temperature of the tank materials, proceeding radially outward from the molten salt interior.

Mechanical issues were also taken into consideration when designing the tank. The internal insulation can transmit the hydrostatic pressure of the molten salt inventory directly to the steel structure. A reliable design was produced by considering the rupture strength of the ceramic. At the same time, the diameter and height of the tank affect the thickness required for the steel housing in order to keep stresses at an acceptable level. The tank was also designed to interface properly with the molten salt pump.

Materials and labor costs are key drivers in the tank economic performance. Significant savings can be gained by using the new, internally insulated design and eliminating the need for expensive nickel alloys in the tank construction. Additional savings can be realized by using carbon steel rather than stainless steel for the tank housing, increasing the internal insulation thickness, and reducing the shell temperature to acceptable levels.

The cold tank design can operate at a temperature of 300° C. with the molten salt. One example of a suitable design includes a carbon steel alloy with external insulation only, and a thin aluminum skin.

A round trip exergetic efficiency of 98% is estimated for the new design. The estimate neglects the parasitic pumping loads from the molten salt pumps. This load is expected to be small relative to the power output of the plant due to the high density of molten salt and the relatively short length of required salt piping in the proposed 2-tank thermal storage system.

Molten salt pump. Molten salt pumps capable of service at 700° C. are not commercially available in the size necessary for the new thermal storage system. For this reason, a custom molten salt pump capable of operating with the inventive compositions at full temperature has been developed. The pump includes a stainless steel impeller and an extended shaft to isolate the motor from the high temperature molten salt [P. Sabharwall et al., “Molten salts for high temperature reactors,” INL/EXT-10-18090, Idaho National Laboratory, Idaho Falls, Id., 2010]. The impeller can include thicker flanges if necessary, or use a nickel based alloy for sufficient strength at 700° C. A commercially available pump designed for water service can be modified for high temperature service with molten salt. For example, a Nagle 316SS centrifugal pump can be modified for use with molten salt [P. Sabharwall et al., 2010].

The cold pump can operate at a temperature of 300° C. with the molten salt. A similar concept, as described above for the hot salt pump, can be used for the cold pump. The design constraints are less stringent for the cold pump due to the lower operating temperature. Stainless steel alloys are sufficient for adequate performance of the cold salt pump.

Thermal power rating for charge and discharge. The inventive system mimics a full scale commercial CSP plant. The present system includes a radiant heat source to heat the molten salt as it flows through a pipe, much like a full scale receiver would do when subject to concentrated insolation. A commercially available laboratory tube furnace can be used as the heat source for the system. Many models are available from manufacturers such as Blue M and others for maximum temperatures up to 1700° C. However, these furnaces are designed to operate under near adiabatic conditions. In the present system, the furnace is actively cooled with the flowing molten salt.

A simple radiative heat sink is used to cool the molten salt at a rate of 5 kWt as it flows from the hot tank to the cold tank. The design includes a series of small diameter pipes through which the salt flows in parallel. A large aluminum panel rests behind the pipes. A fan blows across the pipes and the aluminum panel, producing a large heat transfer coefficient and allowing the heat flux to be controlled by varying the fan speed. A full scale commercial CSP plant uses a steam generator, with preheating, boiling, and superheating sections. The present system, however, is designed for simplicity and does not mimic a full scale CSP plant steam generator in this aspect.

Full system instrumentation. Full instrumentation is used in the inventive system, including instruments for measuring the temperature, pressure, and flow rate at key points. See Table 3 for a list of the instrumentation. Thermocouples are typically K-type or another variety suitable for a molten salt environment. Pressure transducers use a manometer design with the fluid column height measured by laser [P. Sabharwall et al., 2010]. This design avoids direct contact with the hot molten salt. Flow sensors use a thermal flow meter design which inputs a known heat flow and measures the temperature rise in the fluid [P. Sabharwall et al., 2010]. This data can be used to calculate the mass flow rate. All data from the instrumentation is monitored and recorded with a data acquisition system operated with LabVIEW.

TABLE 3
Instrumentation of Thermal Storage Prototype System

| Name | Process parameter | Location | Sensor type |
|---|---|---|---|
| T1 | Temperature | Salt, cold tank | thermocouple |
| T2 | Temperature | Wall, cold tank | thermocouple |
| T3 | Temperature | Salt, furnace inlet | thermocouple |
| T4 | Temperature | Furnace, zone 1 | thermocouple |
| T5 | Temperature | Furnace, zone 2 | thermocouple |
| T6 | Temperature | Furnace, zone 3 | thermocouple |
| T7 | Temperature | Salt, furnace outlet | thermocouple |
| T8 | Temperature | Salt, hot tank | thermocouple |
| T9 | Temperatures | Wall, hot tank | thermocouple |
| T10 | Temperature | Salt, radiator inlet | thermocouple |
| T11 | Temperature | Salt, radiator outlet | thermocouple |
| T12 | Temperature | Air, ambient | thermocouple |
| P1 | Pressure | Salt, cold pump outlet | laser manometer |
| P2 | Pressure | Salt, hot pump outlet | laser manometer |
| F1 | Flow rate | Salt, cold pump outlet | thermal flow meter |
| F2 | Flow rate | Salt, hot pump outlet | thermal flow meter |

### V. Examples

### General

Salt mixtures were formulated and characterized with an automated materials discovery workflow. The first step was to prepare free flowing anhydrous salt components. Components were purchased in reagent grade purity, typically 99% pure, from Sigma Aldrich (St. Louis, Mo.). Each component that was available in anhydrous form was ground with a mortar and pestle and dehydrated in an oven at 115° C. for at least 12 hours. Salt mixtures were formulated using automated robotic systems for dispensing powdered and liquid materials. The powder dispensing system was the MTM Powdernium from Symyx Technologies (Sunnyvale, Calif.). This device measures each component as it is being dispensed and records the final weight with high accuracy. It can dispense many different components to many different mixtures. The mixtures were dispensed into a borosilicate glass plate containing 96 wells in an 8 by 12 array. Each mixture had a total mass of 250 mg. After dispensing, the plate was placed in a furnace purged with nitrogen gas and heated to 500° C. for at least 8 hours in order to ensure complete melting and homogenization of each mixture. After melting the plate was allowed to cool and stored in a desiccator until subsequent testing.

The melting point of each mixture was measured with a Parallel Melting Point Workstation (PMP) from Symyx Technologies (Sunnyvale, Calif.). The PMP allows the melting point for each mixture in the 96 well plate to be measured simultaneously. The PMP heats the plate at a controlled rate and uses an optical method to record the temperature at which each mixture transitions from opaque to clear. This transition corresponds to the liquidus temperature, which is defined as the temperature during heating at which the last remaining solid phase melts and becomes liquid. The liquidus temperature is also equivalent to the temperature during cooling at which a solid phase first appears in the melt (assuming no supercooling). However, supercooling is common with molten salts and therefore only data acquired during a heating mode was used to obtain the melting point. The melting point using this procedure was defined as the liquidus temperature.

The phase diagram is a graphical device that allows the composition and melting point of mixtures to be represented simultaneously (this type of phase diagram is called a polythermal projection). The typical phase diagram is triangular, which allows the plotting of a ternary system of three salts (typically four ions). Each corner of the triangle represents a pure ion and the interior area represents mixtures of varying proportions. The color represents the melting point. A quaternary system of four salts (typically five ions) may be plotted by a series of triangular phase diagrams (Phase Diagrams for Ceramists, vol. 1, describes such diagrams for up to six ions). The location of each ternary diagram along a horizontal axis represents the proportion of the 5^{th} ion. A quinary system of five salts (typically six ions) may be plotted by a two dimensional surface of ternary phase diagrams. Each ternary phase diagram is located at the (x, y) coordinates corresponding to the level of the 5^{th} and 6^{th} ions (ion 5, ion 6). A system of six salts (typically seven ions) may be plotted by a series of two dimensional surfaces of ternary phase diagrams. Each surface represents a constant value of the 7^{th} ion. The drawings included herein show representative phase diagrams from each of the major systems described.

Mixtures that exhibited a low melting point were subjected to further testing for thermal stability. Approximately 20 mg of each mixture was scraped from its well in the glass plate and loaded onto a platinum pan for testing. The theimal stability of mixtures was measured using a Q500 thermogravimetric analysis (TGA) device from TA Instruments (New Castle, Del.). A TGA device heats a sample in a controlled environment and continuously measures the sample weight, which typically decreases at higher temperatures as the sample decomposes into gaseous products. The maximum temperature or thermal stability of a sample, termed “T3,” was defined for screening purposes as the temperature at which it has lost 3% of its anhydrous weight during a TGA test ramping at 10 ° C/min. The anhydrous weight of a salt sample was defined as the weight at 300° C. during the TGA test. Initial weight loss below 300° C. is due to absorbed water evaporating from the sample. Each mixture was tested in two atmospheres, one of air and one of nitrogen, in order to observe the effect of oxidation. The thermal stability using the T3 method typically produces similar results for each mixture in a given system; however significant differences are observed between systems. Therefore only a representative set of mixtures from each system were tested for thermal stability rather than every mixture in the system. The T3 method ranks the mixtures in order of relative stability rather than acting as an absolute measurement of stability. It is a screening test that gives a comparative ranking of candidate salt mixtures.

### Example 1

To prepare a laboratory-scale sample of the Saltstream 700 salt mixture, each salt component was dispensed into a well on a borosilicate glass plate. The sample was heated in a furnace at a temperature of 500° C. for 8 hours to melt and homogenize the sample. The sample was maintained at 115° C. after melting until it was removed from the furnace and allowed to cool to room temperature in a desiccator. The sample was inserted into the PMP Workstation and the temperature was set to 100° C. and allowed to stabilize for 60 minutes. The temperature was then ramped to 315° C. at 20° C./hour.

Salt compositions can be described by specifying the mass of each salt component, which can be translated to molar percent of each ion by those skilled in the art. A salt mixture of any desired size with the same properties (melting point and thermal stability) can be prepared by increasing the amount of each component but maintaining the relative proportions. The examples with salt masses are given for simplicity but do not necessarily embody an exclusive method to achieve a given composition of ions; to exclusively describe a molten salt composition one must specify the ionic composition.

The composition of Saltstream 700, in particular, consists of a novel combination of chlorides of lithium, sodium, potassium, cesium, and strontium (LiCl, NaCl, KCl, CsCl, and SrCl₂). Chlorides are very stable salts but typically have very high melting points. The present invention discloses a mixture with a low eutectic melting point of 253° C., the lowest known melting point of any chloride mixture that is stable to at least 700° C. Some previous work has been done on low-melting chlorides salts relevant for the present invention [P. Masset and R. Guidotti, “Thermal activated (thermal) battery technology Part II. Molten salt electrolytes,” J. Power Sources, vol. 164, pp. 397-414, 2007].

### Example 2

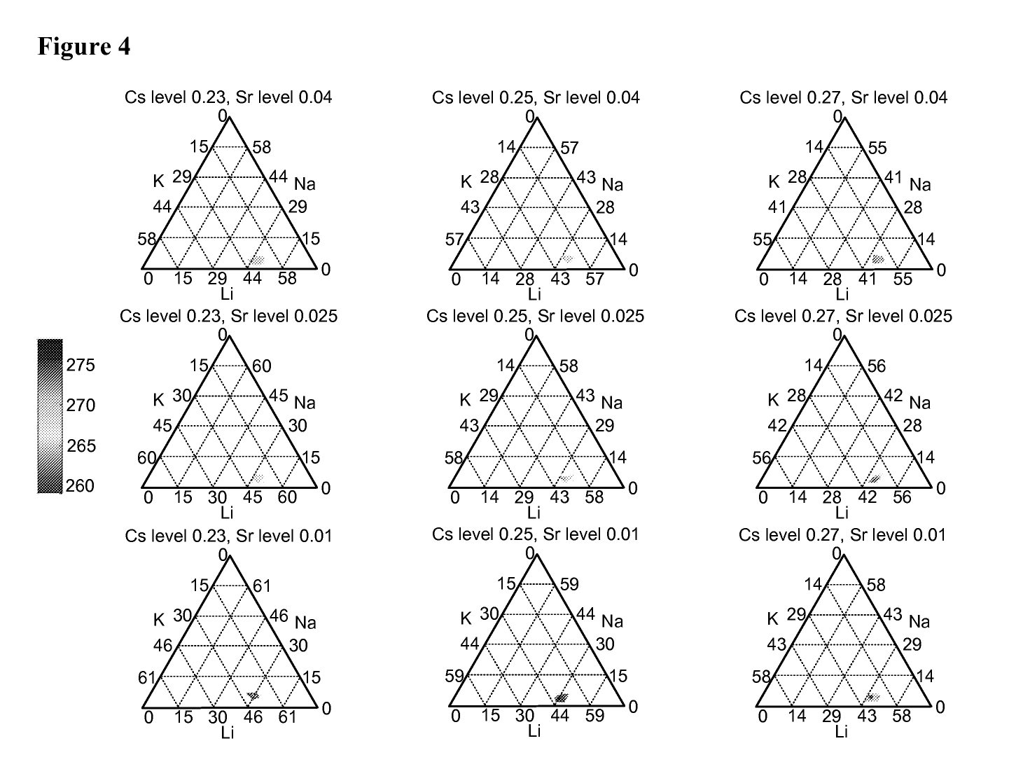

Further examples of each system are given below in Table 4. The phase diagrams for these examples are shown in FIG. 4. These examples are not intended to restrict the scope of the present invention but merely illustrate possible embodiments; other compositions are possible. The composition of each is expressed in molar percent on an ion basis, which can be converted to weight percent by those skilled in the art. The melting point is expressed in degrees Celsius as measured by the PMP.

TABLE 4
Examples of the Present Invention.

| | Li | | | | | | |
|---|---|---|---|---|---|---|---|
| | (mol | Na | Cs | Sr | K | Cl | mp |
| Sample | %) | (mol %) | (mol %) | (mol %) | (mol %) | (mol %) | (° C.) |
| 1 | 48.34 | 3.69 | 23.34 | 0.95 | 23.68 | 100.00 | 259.25 |
| 2 | 47.09 | 3.81 | 22.43 | 1.04 | 25.63 | 100.00 | 259.55 |
| 3 | 46.10 | 2.50 | 24.81 | 1.08 | 25.50 | 100.00 | 259.65 |
| 4 | 46.34 | 6.35 | 22.61 | 1.03 | 23.67 | 100.00 | 259.65 |
| 5 | 46.52 | 2.20 | 22.80 | 1.10 | 27.38 | 100.00 | 259.85 |
| 6 | 43.89 | 4.81 | 24.86 | 1.20 | 25.23 | 100.00 | 259.85 |
| 7 | 44.57 | 6.01 | 22.66 | 0.97 | 25.79 | 100.00 | 259.95 |
| 8 | 41.85 | 6.03 | 22.87 | 1.04 | 28.21 | 100.00 | 260.15 |
| 9 | 48.31 | 1.85 | 24.97 | 1.03 | 23.85 | 100.00 | 260.15 |
| 10 | 44.35 | 1.98 | 24.86 | 0.98 | 27.82 | 100.00 | 260.15 |
| 11 | 44.56 | 4.81 | 22.50 | 1.08 | 27.05 | 100.00 | 260.25 |
| 12 | 46.66 | 5.72 | 25.13 | 1.03 | 21.47 | 100.00 | 260.45 |
| 13 | 45.99 | 4.51 | 25.00 | 1.21 | 23.28 | 100.00 | 260.65 |
| 14 | 47.85 | 4.56 | 26.91 | 2.60 | 18.09 | 100.00 | 261.45 |
| 15 | 48.43 | 4.62 | 26.54 | 1.06 | 19.34 | 100.00 | 262.35 |
| 16 | 46.00 | 2.24 | 26.72 | 2.58 | 22.46 | 100.00 | 262.55 |
| 17 | 44.13 | 6.18 | 24.99 | 1.01 | 23.69 | 100.00 | 262.55 |
| 18 | 44.37 | 4.11 | 27.03 | 2.53 | 21.96 | 100.00 | 262.65 |
| 19 | 42.71 | 6.30 | 26.67 | 3.93 | 20.39 | 100.00 | 262.95 |
| 20 | 46.72 | 3.99 | 26.86 | 2.54 | 19.89 | 100.00 | 262.95 |
| 21 | 43.60 | 4.40 | 24.89 | 2.41 | 24.70 | 100.00 | 262.95 |

### Example 3

Sample Preparation. Reagent grade salts were used to make the salt mixture. LiCl (28.002 g), NaCl (3.333 g), KCl (23.105 g), CsCl (59.601 g), and SrCl₂·6H₂O (10.959 g) were weighed using an analytical balance and thoroughly mixed using a mortar and pestle. The solid mixture was heated at 350° C. overnight in a muffle furnace. The molten liquid was quenched and the solid was broken into small chunks and stored under static atmospheric conditions. A 100 g portion of the above salt mixture was reserved. The remainder of the batch was pulverized and stored under a dynamic flow of dry air before property analysis as described below. The composition of the mixture is summarized below in Table 5.

TABLE 5
Chemical Composition by Weight Percent and Mole Percent

| Component | Weight % | Mole % |
|---|---|---|
| LiCl | 23.2 | 46.4 |
| NaCl | 2.8 | 4.0 |
| KCl | 19.2 | 21.8 |
| CsCl | 49.4 | 24.9 |
| SrCl₂ | 5.4 | 2.9 |
| Total | 100.0 | 100.0 |

Melting Point. A model TA 2920 DSC was used to determine the melting point. Between 5-15 mg of solid sample were placed in an aluminum DSC sample pan. The sample pan was heated to 300° C. for 60 min to melt the material. The sample was analyzed via DSC from ambient temperature to 400° C. heating at a rate of 10° C./min. The sample was uncovered (no lid). The purge gas was a constant flow of Ar at 50 cm³/min. The onset of the melting event was 253° C. The uncertainty with determining the melting point using DSC was ±1.5° C.

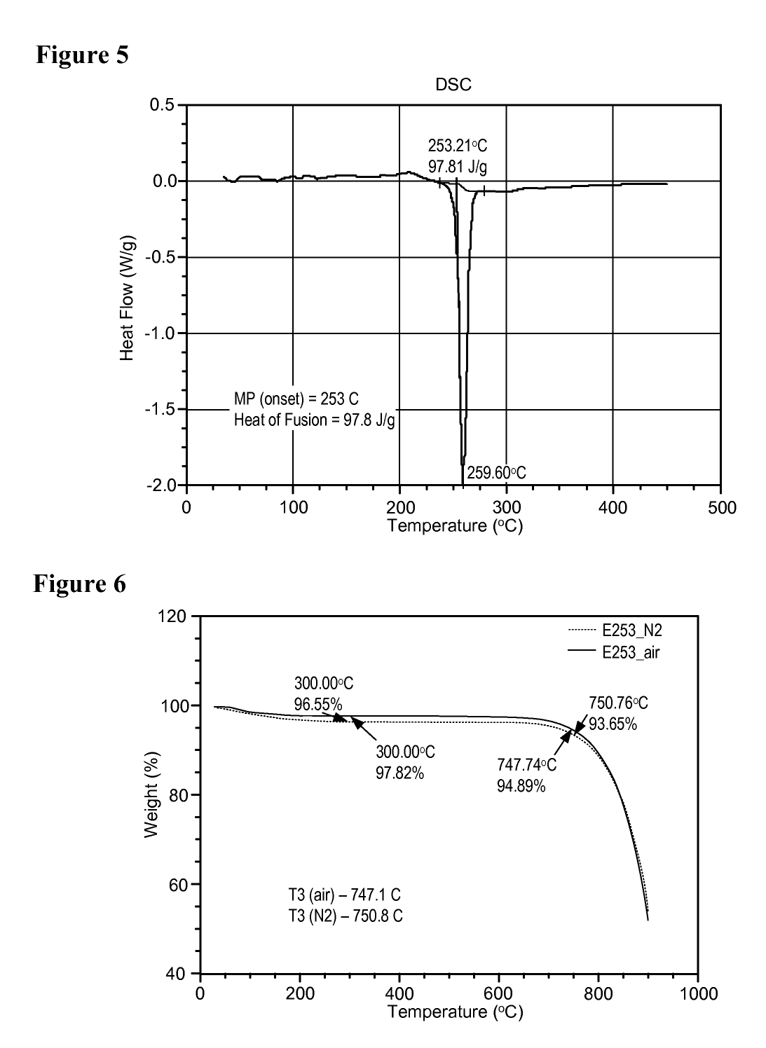

Heat of Fusion. A model TA 2920 DSC was used to determine the heat of fusion. Between 5-15 mg of solid sample were placed in a pre-tared aluminum DSC sample pan weighed to ±0.01 mg. The sample pan was heated to 300° C. for 60 min to melt and dehydrate the material. The sample pan was immediately reweighed to ±0.01 mg after the dehydration step to obtain the dry mass. The sample was analyzed via DSC from ambient temperature to 400° C. at a rate of 10° C./min. The sample was uncovered (no lid). The purge gas was a constant flow of Ar at 50 cm³/min. The energy required to melt the sample was measured and used in conjunction with the mass of the dehydrated sample to calculate the heat of fusion. The uncertainty of measuring the heat of fusion using a DSC was ±2.8%. The thermogram showing the melting point and heat of fusion is shown in FIG. 5.

Thermal Stability. The maximum working temperature of the sample in both air and nitrogen was determined using a TGA as described in “Development of molten salt heat transfer fluid with low melting point and high thermal stability,” Journal of Solar Energy Engineering, vol. 133, issue 3, August 2011, by J. W. Raade and D. Padowitz. The thermal stability, turned T3, is defined as the temperature at which it has lost 3.00% of its anhydrous weight while heated at a rate of 10° C./min while the furnace was purged with the gas of interest at a rate of 60 cm³/min. The anhydrous weight was defined as the weight of the sample at 300° C. while subjected to a heating rate of 10° C./min from ambient temperature. The TGA profiles showing the thermal stability are shown in FIG. 6. The TGA test indicates stability up to 700° C., but is also prone to measure simple evaporation of the salt rather than chemical decomposition. A long-term stability test was performed by holding a sample of the salt in a furnace maintained at 700° C. for 168 hours. Before the test the sample (in 5 wt % aqueous solution) had a pH of 5. After the test the pH was 7. This result indicates that negligible decomposition occurred to oxides, hydroxides, or other basic components.

Heat Capacity. A model TA 2920 DSC was used to obtain the heat capacity. The heat capacity at constant pressure was measured by measuring the heat flux of the sample at the temperature of interest and comparing it to the heat flux of a sample of sapphire at the temperature of interest as the sample was heated a rate of 20° C./min under a flow of Ar at 50 cm³/min. The heat flux data is correlated to C_{P} in a relationship detailed in ASTM E1269-05. The uncertainty of measuring heat capacity using this method was 8.4%.

Viscosity. The viscosity was measured using a Brookfield Viscometer DV-II+ Pro Extra, a spindle (SC4-18 17.5 mm diameter), and a crucible (19 mm inner diameter). The viscometer crucible furnace was modified to reach a maximum temperature of 500° C. The uncertainty of the viscosity measurement was 1.0%, according to the Brookfield Viscometer Operating Instructions Manual.

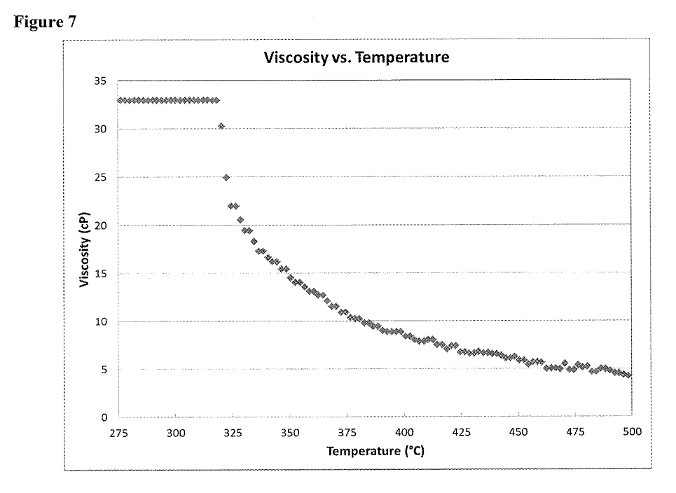

For the viscosity measurement a 25 g sample of the molten salt mixture was heated from 275° C. to 500° C. at approximately 5° C./min. The viscosity was measured at a constant shear rate of 132 sec⁻¹, which corresponds to 100 rpm. The flat line at approximately 33 cP at low temperature is due to the maximum viscosity limitations of the spindle. Viscosity as a function of temperature is plotted in FIG. 7. The numerical data is summarized in Table 6.

TABLE 6
Viscosity Data

| Temperature | Viscosity |
|---|---|
| (° C.) | (cP) |
| 276.2 | 32.99 |
| 278.3 | 32.99 |
| 280.3 | 32.99 |
| 282.4 | 32.99 |
| 284.4 | 32.99 |
| 286.4 | 32.99 |
| 288.4 | 32.99 |
| 290.4 | 32.99 |
| 292.3 | 32.99 |
| 294.5 | 32.99 |
| 296.4 | 32.99 |
| 298.5 | 32.99 |
| 300.4 | 32.99 |
| 302.5 | 32.99 |
| 304.5 | 32.99 |
| 306.6 | 32.99 |
| 308.6 | 32.99 |
| 310.5 | 32.99 |
| 312.6 | 32.99 |
| 314.5 | 32.99 |
| 316.6 | 32.99 |
| 318.5 | 32.99 |
| 320.6 | 30.26 |
| 322.6 | 24.92 |
| 324.6 | 21.99 |
| 326.7 | 21.99 |
| 328.7 | 20.55 |
| 330.6 | 19.44 |
| 332.6 | 19.44 |
| 334.6 | 18.30 |
| 336.7 | 17.28 |
| 338.5 | 17.28 |
| 340.7 | 16.65 |
| 342.6 | 16.17 |
| 344.6 | 16.17 |
| 346.6 | 15.42 |
| 348.8 | 15.42 |
| 350.7 | 14.52 |
| 352.6 | 14.01 |
| 354.6 | 14.01 |
| 356.7 | 13.56 |
| 358.7 | 13.08 |
| 360.7 | 13.08 |
| 362.6 | 12.69 |
| 364.7 | 12.69 |
| 366.6 | 12.09 |
| 368.7 | 11.52 |
| 370.5 | 11.52 |
| 372.7 | 10.92 |
| 374.7 | 10.92 |
| 376.8 | 10.35 |
| 378.7 | 10.20 |
| 380.6 | 10.20 |
| 382.7 | 9.78 |
| 384.7 | 9.78 |
| 386.6 | 9.42 |
| 388.7 | 9.42 |
| 390.7 | 8.97 |
| 392.7 | 8.85 |
| 394.7 | 8.85 |
| 396.7 | 8.88 |
| 398.7 | 8.88 |
| 400.7 | 8.40 |
| 402.7 | 8.40 |
| 404.8 | 8.04 |
| 406.8 | 7.86 |
| 408.8 | 7.86 |
| 410.7 | 8.04 |
| 412.7 | 8.04 |
| 414.6 | 7.50 |
| 416.7 | 7.50 |
| 418.7 | 7.02 |
| 420.7 | 7.38 |
| 422.7 | 7.38 |
| 424.7 | 6.72 |
| 426.7 | 6.72 |
| 428.6 | 6.60 |
| 430.7 | 6.60 |
| 432.6 | 6.78 |
| 434.7 | 6.63 |
| 436.7 | 6.63 |
| 438.6 | 6.57 |
| 440.6 | 6.57 |
| 442.7 | 6.39 |
| 444.6 | 6.09 |
| 446.7 | 6.09 |
| 448.6 | 6.27 |
| 450.5 | 5.88 |
| 452.7 | 5.88 |
| 454.6 | 5.43 |
| 456.5 | 5.70 |
| 458.6 | 5.70 |
| 460.5 | 5.64 |
| 462.6 | 5.01 |
| 464.6 | 5.04 |
| 466.6 | 5.04 |
| 468.5 | 4.95 |
| 470.5 | 5.52 |
| 472.5 | 4.86 |
| 474.6 | 4.86 |
| 476.5 | 5.40 |
| 478.5 | 5.13 |
| 480.5 | 5.19 |
| 482.4 | 4.65 |
| 484.4 | 4.65 |
| 486.4 | 5.01 |
| 488.4 | 4.95 |
| 490.4 | 4.77 |
| 492.5 | 4.50 |
| 494.4 | 4.50 |
| 496.4 | 4.35 |
| 498.4 | 4.20 |

Density calculations. The density was calculated using a weighted average of the components. The dependence of the density on the temperature was obtained from Janz, George C., Molten Salt Handbook, Academic Press, 1967, pp 39. Calculated density values are shown in Table 7.

TABLE 7
Calculated Density as a Function of Temperature

| Temperature | Density |
|---|---|
| (° C.) | (g/cm³) |
| 300 | 2.26 |
| 350 | 2.23 |
| 400 | 2.20 |
| 450 | 2.18 |
| 500 | 2.15 |
| 550 | 2.12 |
| 600 | 2.09 |
| 650 | 2.06 |
| 700 | 2.03 |

Physical properties of the mixture are summarized in Table 1.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A composition comprising:
a lithium cation, in an amount of from about 0 to about 55 mol % based on the cations;
a sodium cation, in an amount of from about 0 to about 20 mol % based on the cations;
a potassium cation, in an amount of from about 15 to about 50 mol % based on the cations;
a cesium cation, in an amount of from about 0 to about 35 mol % based on the anions;
a strontium cation, in an amount of from about 0 to about 10 mol % based on the cations; and
a chloride anion in an amount of 100 mol % based on the anions.

2. The composition of claim 1, wherein the lithium cation is present in an amount of from about 1 to about 55 mol % based on the cations.

3. The composition of claim 1, wherein the lithium cation is present in an amount of from about 30 to about 55 mol % based on the cations.

4. The composition of claim 1, wherein the lithium cation is present in an amount of from about 40 to about 50 mol % based on the cations.

5. The composition of claim 1, wherein the sodium cation is present in an amount of from about 0.1 to about 10 mol % based on the cations.

6. The composition of claim 1, wherein the sodium cation is present in an amount of from about 1 to about 10 mol % based on the cations.

7. The composition of claim 1, wherein the potassium cation is present in an amount of from about 15 to about 30 mol % based on the cations.

8. The composition of claim 1, wherein the cesium cation is present in an amount of from about 10 to about 35 mol % based on the cations.

9. The composition of claim 1, wherein the cesium cation is present in an amount of from about 20 to about 30 mol % based on the cations.

10. The composition of claim 1, wherein the strontium cation is present in an amount of from about 0.1 to about 5 mol % based on the cations.

11. The composition of claim 1, wherein the strontium cation is present in an amount of from about 1 to about 5 mol % based on the cations.

12. The composition of claim 1, comprising
the lithium cation, in an amount of from about 40 to about 50 mol % based on the cations;
the sodium cation, in an amount of from about 0.1 to about 10 mol % based on the cations;
the potassium cation, in an amount of from about 15 to about 30 mol % based on the cations;
the cesium cation, in an amount of from about 20 to about 30 mol % based on the cations;
the strontium cation, in an amount of from about 0.1 to about 5 mol % based on the cations; and
the chloride anion in an amount of 100 mol % based on the anions.

13. The composition of claim 1, comprising the lithium cation, in an amount of about 46 mol % based on the cations;
the sodium cation, in an amount of about 4 mol % based on the cations;
the potassium cation, in an amount of about 22 mol % based on the cations;
the cesium cation, in an amount of about 25 mol % based on the cations;
the strontium cation, in an amount of about 3 mol % based on the cations; and
the chloride anion in an amount of 100 mol % based on the anions.

14. The composition of claim 1, wherein the melting point is less than about 300° C.

15. The composition of claim 1, wherein the thermal stability limit is greater than about 700° C.

16. A method for storing solar theimal energy comprising exposing a composition to sunlight, wherein the composition comprises:
a lithium cation, in an amount of from about 0 to about 55 mol % based on the cations;
a sodium cation, in an amount of from about 0 to about 20 mol % based on the cations;
a potassium cation, in an amount of from about 15 to about 50 mol % based on the cations;
a cesium cation, in an amount of from about 0 to about 35 mol % based on the cations;
a strontium cation, in an amount of from about 0 to about 10 mol % based on the cations; and
a chloride anion in an amount of 100 mol % based on the anions.

17. The method of claim 16, wherein the composition comprises:
the lithium cation, in an amount of from about 40 to about 50 mol % based on the cations;
the sodium cation, in an amount of from about 0.1 to about 10 mol % based on the cations;
the potassium cation, in an amount of from about 15 to about 30 mol % based on the cations;
the cesium cation, in an amount of from about 20 to about 30 mol % based on the cations;
the strontium cation, in an amount of from about 0.1 to about 5 mol % based on the cations; and
the chloride anion in an amount of 100 mol % based on the anions.

18. The method of claim 16, wherein the composition comprises:
the lithium cation, in an amount of about 46 mol % based on the cations;
the sodium cation, in an amount of about 4 mol % based on the cations;
the potassium cation, in an amount of about 22 mol % based on the cations;
the cesium cation, in an amount of about 25 mol % based on the cations;
the strontium cation, in an amount of about 3 mol % based on the cations; and
the chloride anion in an amount of 100 mol % based on the anions.
